(19) United States
(12) Patent Application Publication
(10) Pub. No.: US 2025/0346134 A1
(43) Pub. Date: Nov. 13, 2025

(54) CHARGING DEVICE

(71) Applicant: LG ELECTRONICS INC., Seoul (KR)

(72) Inventors: Kangsuk LEE, Seoul (KR); Suk KO, Seoul (KR); Sunghwan OH, Seoul (KR); Myoungku LEE, Seoul (KR)

(73) Assignee: LG ELECTRONICS INC., Seoul (KR)

(21) Appl. No.: 18/766,768

(22) Filed: Jul. 9, 2024

(30) Foreign Application Priority Data
May 8, 2024 (WO) PCT/KR2024/006187

(51) Int. Cl. B60L 53/30; B60L 53/14; B60L 53/62; B60L 58/12; H04R 1/02

(52) U.S. Cl. CPC B60L 53/305; B60L 53/14; B60L 53/62; B60L 58/12; H04R 1/028

(57) ABSTRACT

Disclosed is a charging device including a main body having a cable connected charger located therein, a front door covering a front surface of the main body and having a plurality of sound holes formed therein, and a sound unit located inside the front door to discharge sound through a plurality of the sound holes, the sound unit including a speaker generating the sound and a housing having a top surface and a front surface open to have an inner space connected to a plurality of the sound holes, wherein the speaker may be located on the top surface of the housing.

Pursuant to 35 U.S.C. § 119 (a), the present application claims the benefit of earlier filing date and right of priority to the International Application No. PCT/KR 2024/006187, filed on May 8, 2024, the contents of which are hereby incorporated by reference herein in their entirety.

### BACKGROUND OF THE DISCLOSURE

### Field of the Disclosure

The present embodiments relate to a charging device, and more particularly, to a charging device including a speaker that is not directly connected to a sound hole.

### Discussion of the Related Art

In general, Electric Vehicles (EVs) have not been put to practical use for a long time due to problems such as heavy weight of a battery mounted in a vehicle and a charging time of the battery and the like compared to gasoline or diesel vehicles. However, due to the recent depletion of fossil energy and environmental pollution, research and development have been actively conducted as interest in electric vehicles that do not use fossil energy and use electric energy has increased.

As a result, the spread of electric vehicles is increasing in recent years. An electric vehicle includes a battery that supplies power for driving, and has a structure in which power is stored in the battery. Therefore, in order to continuously operate the electric vehicle, the battery should be charged. Accordingly, an infrastructure for charging an electric vehicle is required, and fixedly installed standing charging facilities are being provided in various places to meet the increasing demand for electric vehicles.

In particular, a charging device includes a speaker that informs a user of a charging state of the charging device by sound for the user's convenience. However, in case of a charging device provided outdoors in general, there is a problem that moisture flows into a sound hole to cause frequent malfunction of a speaker.

### SUMMARY OF THE DISCLOSURE

Accordingly, embodiments of the present disclosure are directed to a charging device that substantially obviates one or more problems due to limitations and disadvantages of the related art.

One object of the present disclosure is to provide a charging device including a speaker coupled to a speaker hole indirectly rather than directly.

Another object of the present disclosure is to provide a charging device that prevents water retention inside a housing by obliquely forming top and bottom surfaces of the housing directly coupled to a sound hole.

Additional advantages, objects, and features of the disclosure will be set forth in the disclosure herein as well as the accompanying drawings. Such aspects may also be appreciated by those skilled in the art based on the disclosure herein.

To achieve these objects and other advantages and in accordance with the purpose of the disclosure, as embodied and broadly described herein, a charging device according to the present disclosure may include a main body having a cable connected charger located therein, a front door covering a front surface of the main body and having a plurality of sound holes formed therein, and a sound unit located inside the front door to discharge sound through a plurality of the sound holes, the sound unit including a speaker generating the sound and a housing having a top surface and a front surface open to have an inner space connected to a plurality of the sound holes, wherein the speaker may be located on the top surface of the housing.

A bottom surface of the housing may be formed to have an inclination at a predetermined angle in an upward direction from the front surface.

The top surface of the housing may be formed to have an inclination at a predetermined angle in a downward direction from the front surface.

A size of the front surface of the housing may be formed greater than that of a rear surface of the housing.

The sound unit may further include a sealing member formed along a flange forming the front surface of the housing.

At least one sound hole located at a lower end among a plurality of the sound holes may be formed at a position where the at least one sound hole meets a lower edge forming a flange of the front surface of the housing.

The sound unit may further include a metal member in a hollow shape having one end coupled to the front door and the other end coupled to the front surface of the housing.

The charging device may further include a hidden button located inside the front door and formed at a position corresponding to one of a plurality of the sound holes.

The hidden button may not be exposed externally.

Accordingly, the present disclosure provides the following effects and/or advantages.

According to embodiments, there is an effect that a speaker may be used irrespective of the standard by providing a charging device including a speaker coupled a sound hole indirectly rather than directly.

According to embodiments, a charging device that prevents water retention from occurring inside a housing is provided by obliquely forming top and bottom surfaces of the housing directly coupled to a sound hole, thereby preventing damage caused to the charging device due to moisture.

The effects obtained by the present disclosure are not limited to the above-mentioned effects, and other effects not mentioned will be clearly understood by those skilled in the art to which the present disclosure pertains from the following description.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of the present application, illustrate embodiment(s) of the disclosure and together with the description serve to explain the principle of the disclosure. The above and other aspects, features, and advantages of the present disclosure will become more apparent upon consideration of the following description of preferred embodiments, taken in conjunction with the accompanying drawing figures. In the drawings:

FIG. 1 is a diagram illustrating a charging device according to embodiments;

FIG. 2 is a diagram illustrating a cross section taken along a direction A-A′ of FIG. 1;

FIG. 3 is a diagram illustrating a sound unit of a charging device according to embodiments;

FIG. 4 is a diagram illustrating a sound unit and a sound hole of a charging device according to embodiments;

FIG. 5 is a diagram illustrating a path along which water moves in a housing of a charging device according to embodiments;

FIG. 6 is a diagram illustrating a direction in which sound is discharged from a housing of a charging device according to embodiments;

FIG. 7 is a diagram illustrating a hidden button of a charging device according to embodiments;

FIG. 8 is a diagram illustrating a cross section taken along a direction B-B′ of FIG. 7;

FIG. 9 is a diagram illustrating a charging device according to other embodiments; and

FIG. 10 is a diagram illustrating a hidden button of a charging device according to other embodiments.

### DETAILED DESCRIPTION OF THE DISCLOSURE

Description will now be given in detail according to exemplary embodiments disclosed herein, with reference to the accompanying drawings. The same or equivalent components may be provided with the same reference numbers, and description thereof will not be repeated. As used herein, the suffixes “module” and “part” are added or used interchangeably to facilitate preparation of this specification and are not intended to suggest distinct meanings or functions. In describing embodiments disclosed in this specification, relevant well-known technologies may not be described in detail in order not to obscure the subject matter of the embodiments disclosed in this specification. In addition, it should be noted that the accompanying drawings are only for easy understanding of the embodiments disclosed in the present specification, and should not be construed as limiting the technical spirit disclosed in the present specification. As such, the present disclosure should be construed to extend to any alterations, equivalents and substitutes in addition to those which are particularly set out in the accompanying drawings.

Although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, it will be understood that when an element is referred to as being “directly connected with” another element, there are no intervening elements present.

A singular representation may include a plural representation unless it represents a definitely different meaning from the context.

The terms such as “include” or “have” used herein are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

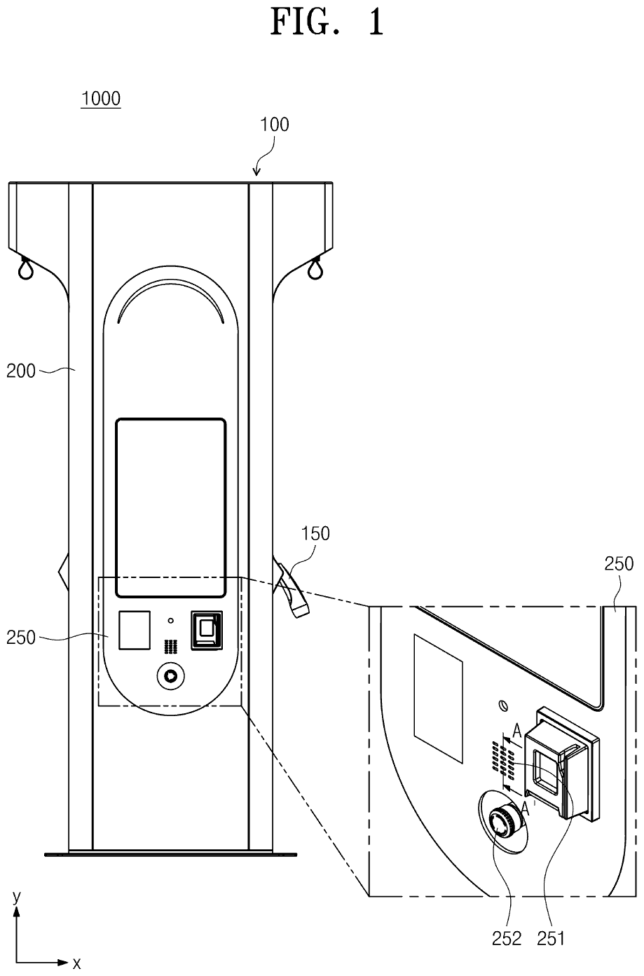

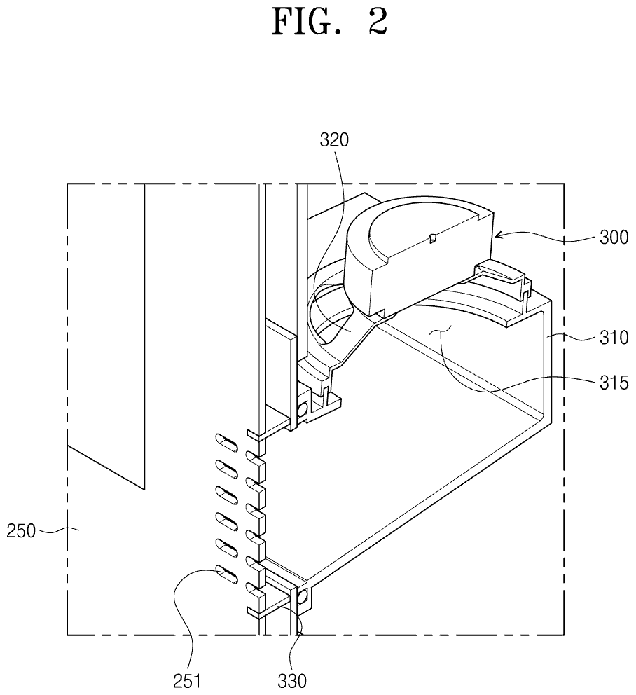

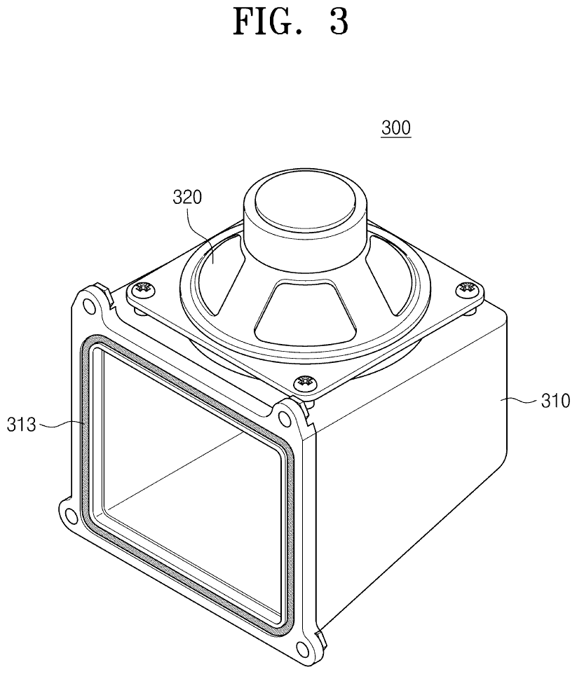

FIG. 1 is a view illustrating a charging device according to embodiments. FIG. 2 is a cross-sectional diagram taken along a direction A-A′ of FIG. 1. FIG. 3 is a diagram illustrating a sound unit of a charging device according to embodiments.

A sound unit 300 illustrated in FIG. 2 corresponds to a sound unit 300 illustrated in FIG. 1. A sound unit 300 illustrated in FIG. 3 corresponds to the sound unit 300 illustrated in FIG. 1 or FIG. 2.

Hereinafter, in describing a charging device 1000 according to embodiments, a horizontal (i.e., right-and-left) direction is described based on an x-axis direction, a vertical direction is described based on a y-axis direction, and a direction toward a front/rear surface is described based on a z-axis direction.

Referring to FIGS. 1 to 3, a charging device 1000 according to embodiments may include a main body 100, a front door 200, a sound unit 300, and the like.

The charging device 1000 according to the embodiments may be a type of device for charging an Electric Vehicle (EV). More specifically, the charging device 1000 according to the embodiments may correspond to an EV charger dispenser, which is one of devices used when charging the electric vehicle. A dispenser is a device that stores and protects a charging cable, and is generally installed in combination with a charger, and a user may pull the cable connected to the charger from the dispenser and connect the cable to the electric vehicle.

A charger 150 to which a cable is connected is positioned in the main body 100, and an LED indicator or screen indicating a charging state may be built in the main body 100.

The front door 200 is configured to cover a front surface and some of a side surface of the main body 100, and may display an LED indicator, a screen, and the like indicating a charging state. The front door 200 may include a display cover 250, and a sound hole 251 and an emergency button 252 may be formed in the front door 200.

As shown in FIG. 2, the sound unit 300 may be positioned inside the front door 200 and discharge sound through a plurality of sound holes 251. The sound unit 300 may include a speaker 320 and a housing 310.

The speaker 320 is configured to generate sound and may be generally the same as a speaker used in a charging device of the related art.

The housing 310 may have the speaker 320 positioned on a top surface thereof and a front surface of the housing 310 is open such that an inner space of the housing 310 may be connected to the sound hole 251. That is, a speaker of the related art charging device is positioned in a direction in which the speaker is directly connected to the sound hole, i.e., directly attached to a front door. Instead, the speaker 320 of the charging device 1000 according to the embodiments is not directly connected to the sound hole 251, the housing 310 is directly connected to the sound hole 251, and the speaker 320 may be indirectly connected to the sound hole 251 through the inner space of the housing 310.

Accordingly, the sound unit 300 of the charging device 1000 according to the embodiments has an effect of preventing a problem caused by moisture because moisture introduced through the sound hole 251 is not directly delivered to the speaker 320.

In addition, referring to FIG. 3, a sealing member 313 formed along a flange that forms the front surface of the housing 310 may be included in the front surface of the housing 310. Since the sealing member 313 is formed, the charging device 1000 according to the embodiments may prevent moisture from penetrating into the coupling between the front door 200 and the housing 310.

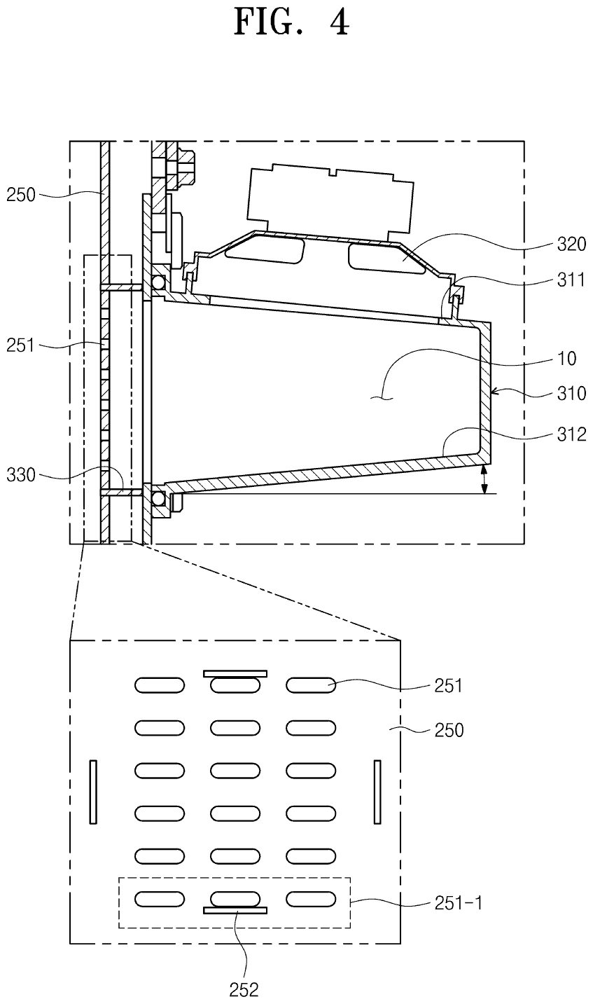

FIG. 4 is a diagram illustrating a sound unit and a sound hole of a charging device according to embodiments.

A housing 310 shown in FIG. 4 corresponds to the housing 310 shown in FIG. 2 and FIG. 3. A display cover 250 shown in FIG. 4 corresponds to the display cover 250 shown in FIG. 1.

Hereinafter, the sound unit 300 will be described in more detail with reference to FIG. 4.

Referring to FIG. 4, a top surface 311 and a bottom surface 312 of the housing 310 may be formed to have a predetermined angle with respect to the front door 200. More specifically, the top surface 311 may be formed to be inclined at a predetermined angle in a downward direction, and the bottom surface 312 may be formed to be inclined at a predetermined angle in an upward direction. In this case, the predetermined angle may be 15 degrees.

Therefore, when moisture flows through the sound hole 251, the moisture does not move to the speaker 320 along an inner space 10 of the housing 310. And the bottom surface 312 of the housing 310 is formed to be inclined so that the moisture may be discharged back to the sound hole 251 by the inclination of the bottom surface 312 before moving to the speaker 320.

In addition, a sound hole 251-1 located at the lower end among a plurality of sound holes 251 may be formed at a position where the sound hole 251-1 meets the lower edge forming the flange of the front surface of the housing 310. That is, the sound hole 251-1 located at the lower end and the lower edge forming the front surface of the housing 310 may be formed at the same position without a step difference.

Accordingly, the lower edge forming the front surface of the housing 310 is also formed at the position where the lower edge meets the sound hole 251, thereby preventing water retention in the inner space 10 of the housing 310. That is, since the lower edge is formed without a step difference from the sound hole 251, the water retention due to a step difference may be prevented.

In addition, the sound unit 300 may include a metal member 330 having one end coupled to the front door 200 and the other end coupled to the front surface of the housing 310. That is, according to embodiments, the housing 310 may be directly coupled to the front door 200 or indirectly coupled to the front door 200 through the metal member 330 as a medium.

The metal member 330 may be provided between the front door 200 and the housing 310, and may prevent a sound loss that may occur between the front door 200 and the housing 310. Accordingly, the metal member 330 may have a hollow shape in which only an edge is formed and an inside thereof is opened so as not to interrupt connection between the sound hole 251 and the inner space of the housing 310.

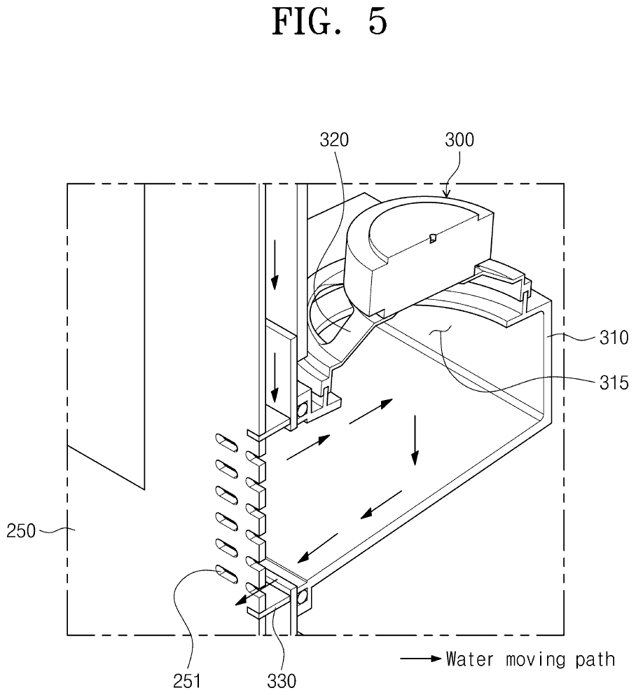

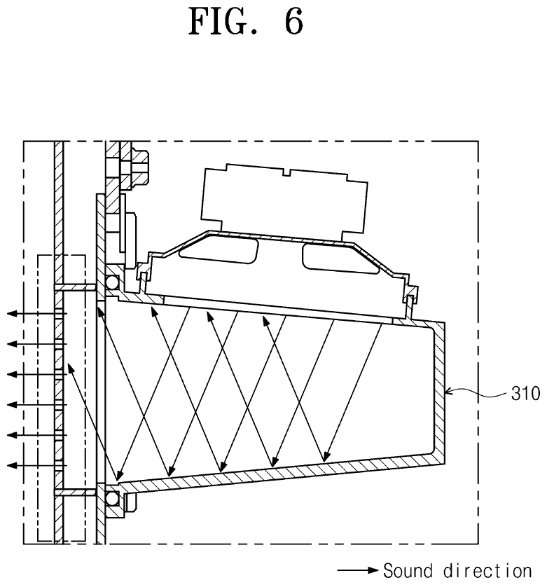

FIG. 5 is a diagram illustrating a path through which water moves in a housing of a charging device according to embodiments. FIG. 6 is a diagram illustrating a direction in which sound is discharged from a housing of a charging device according to embodiments.

A housing 310 shown in FIG. 5 corresponds to the housing 310 shown in FIGS. 2 to 4. A housing 310 shown in FIG. 6 corresponds to the housing 310 shown in FIGS. 2 to 5. An inner space 10 shown in FIG. 6 corresponds to the inner space 10 shown in FIG. 4.

Referring to FIG. 5, moisture flowing into the housing 310 through the sound hole 251 may be discharged through the sound hole 251 again along the inner space 10 of the housing 310, more specifically, the top surface 311 and the bottom surface 312.

In particular, a hole 315 corresponding to a size of the speaker 320 may be formed in the top surface 311 so that the speaker 320 is located, and thus moisture introduced through the sound hole 251 may move downward along the edge of the hole 315 but may not move toward the speaker 320.

In addition, as described above, the moisture that has moved downward moves in the front direction rather than the rear direction of the housing 310 by the slope of the bottom surface 312 of the housing 310, and as a result, may be discharged to the outside through the sound hole 251.

In addition, referring to FIG. 6, the sound generated by the speaker 320 may be reflected on the top surface 311 and the bottom surface 312 forming the inner space 10 of the housing 310 and discharged through the sound hole 251. Accordingly, even though the inner space 10 of the housing 310 is not directly connected to the sound hole 251 as a kind of sound box, the sound generated by the speaker 320 may be clearly transmitted to the outside of the sound hole 251.

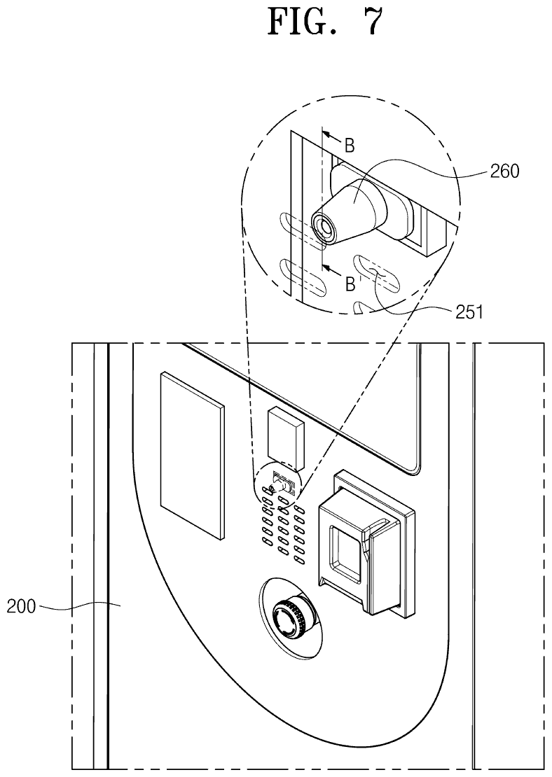

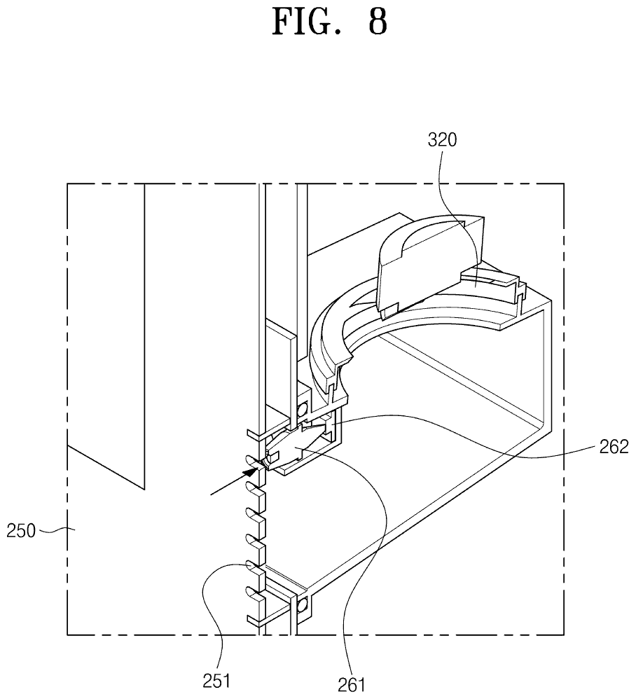

FIG. 7 is a diagram illustrating a hidden button of a charging device according to embodiments. FIG. 8 is a diagram illustrating a cross section taken along a direction B-B′ of FIG. 7.

A front door 200 illustrated in FIG. 7 corresponds to the front door 200 illustrated in FIG. 1.

Referring to FIG. 7 and FIG. 8, the charging device 1000 according to the embodiments may include a hidden button 260 positioned inside the front door 200 and formed at a position corresponding to a sound hole 251 among a plurality of the sound holes 251. The hidden button 260 may be one of various types of buttons, for example, a reset button.

The hidden button 260 may be pressed by a user through the sound hole 251. More specifically, the user may press the hidden button 260 through the sound hole 251 using a thin stick such as a needle or the like.

The hidden button 260 may include a button part 261 and a Printed Circuit Board (PCB) 262 that is in contact with the button part 261. The user may press the button part 261 and, by the user's pressing, the button part 261 may be moved in the rear direction of the front door 200. In addition, as the button part 261 is moved in the rear direction, it may be in contact with the printed circuit board 262 located behind the button part 261, so that the hidden button 260 may be activated.

The hidden button 260 is positioned inside the front door 200 and is not exposed to the outside thereof. Therefore, the user may easily distinguish between an emergency stop button 252 additionally positioned outside the front door 200 and the hidden button 260 positioned inside the front door 200 without being confused.

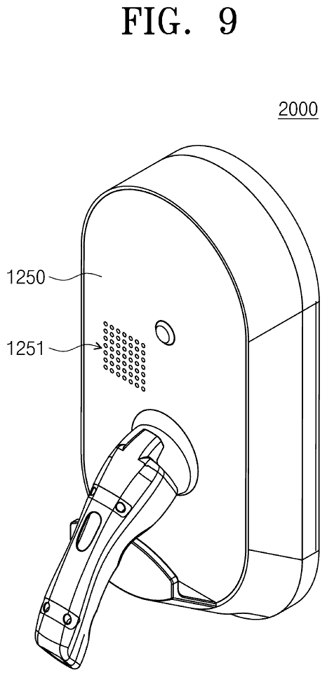

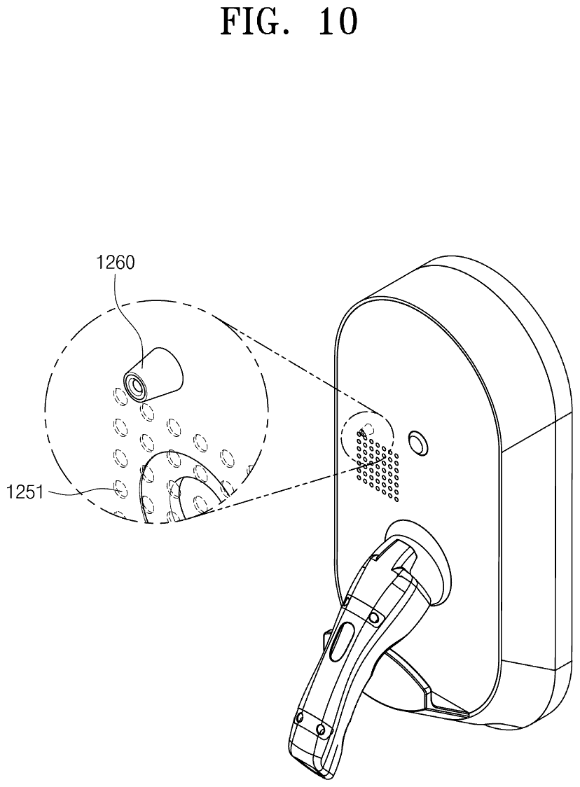

FIG. 9 is a diagram illustrating a charging device according to other embodiments. FIG. 10 is a diagram illustrating a hidden button of a charging device according to other embodiments.

A sound hole 1251 illustrated in FIG. 10 corresponds to a sound hole 1251 illustrated in FIG. 9.

A charging device 2000 according to embodiments shown in FIG. 9 and FIG. 10 may correspond to a wall-mounted type charging device that is hung and fixed to a wall, unlike the charging device 1000 according to the embodiments shown in FIG. 1. That is, the charging device 1000 according to the embodiments shown in FIG. 1 is a type of charging device that is fixed to the ground/road surface, and the charging device 2000 according to the embodiments shown in FIG. 9 and FIG. 10 is a type of charging device that is hung and fixed to a wall.

The charging device 1000 shown in FIG. 1 and the charging device 2000 shown in FIG. 9 differ only in fixed positions, and unless the description of the charging device 1000 shown in FIG. 1 is incompatible, the same may be applied to the charging device 2000 shown in FIG. 9.

Referring to FIG. 9 and FIG. 10, the charging device 2000 according to the embodiments may have a sound hole 1251 formed in a front door 1250. The front door 1250 and the sound hole 1251 are the same as the front door 200 and the sound hole 251 described in FIGS. 1 to 8.

A hidden button 1260 may be positioned inside the front door 1250, and the hidden button 1260 may be formed at a position corresponding to one sound hole 1251 among a plurality of sound holes 1251. That is, a user may activate the hidden button 1260 through the sound hole 1251. The hidden button 1260 is the same as the hidden button 260 described in FIG. 8 and FIG. 9.

The detailed description of the preferred embodiments of the present disclosure disclosed as described above has been provided to allow those skilled in the art to embody and implement the present disclosure. Although the above has been described with reference to the preferred embodiments of the present disclosure, those skilled in the art will understand that the present disclosure may be variously modified and changed without departing from the scope of the present disclosure. For example, those skilled in the art may use each of the components described in the above-described embodiments in a manner of combining them with each other.

Therefore, the present disclosure is not intended to be limited to the embodiments shown here, but to give a maximum scope consistent with the principles and new features disclosed herein.

What is claimed is:

1. A charging device, comprising:
a main body having a cable connected charger located therein;
a front door covering a front surface of the main body and having a plurality of sound holes formed therein; and
a sound unit located inside the front door to discharge sound through the plurality of the sound holes, the sound unit comprising:
a speaker generating the sound; and
a housing having a front surface open to have an inner space connected to the plurality of the sound holes,
wherein the speaker is located on the top surface of the housing.

2. The charging device of claim 1, wherein a bottom surface of the housing is formed to have an inclination at a predetermined angle in an upward direction from the front surface of the housing.

3. The charging device of claim 1, wherein a top surface of the housing is formed to have an inclination at a predetermined angle in a downward direction from the front surface of the housing.

4. The charging device of claim 1, wherein a size of the front surface of the housing is formed greater than that of a rear surface of the housing.

5. The charging device of claim 1, the sound unit further comprising a sealing member formed along a flange forming the front surface of the housing.

6. The charging device of claim 1, wherein at least one sound hole located at a lower end among the plurality of the sound holes is formed at a position where the at least one sound hole meets a lower edge forming a flange of the front surface of the housing.

7. The charging device of claim 1, the sound unit further comprising a metal member in a hollow shape having one end coupled to the front door and the other end coupled to the front surface of the housing.

8. The charging device of claim 1, further comprising a hidden button located inside the front door and formed at a position corresponding to one of the plurality of the sound holes.

9. The charging device of claim 8, wherein the hidden button is not exposed externally.
